(19) United States
(12) Patent Application Publication
(10) Pub. No.: US 2007/0001328 A1
(43) Pub. Date: Jan. 4, 2007

(54) Method of moulding contact lenses and moulding apparatus for use in the method

(75) Inventor: Michael Kelly, Southampton (GB)

Correspondence Address: GABLE & GOTWALS, 100 WEST FIFTH STREET, 10TH FLOOR, TULSA, OK, 74103, US

(73) Assignee: VISAQ LIMITED, Abbey Industrial Estate (GB)

(21) Appl. No.: 10/569,558

(22) PCT Filed: Aug. 27, 2004
(86) PCT No.: PCT/GB04/03677

§ 371 Date: Feb. 27, 2006

(30) Foreign Application Priority Data
Aug. 29, 2003 (GB) 0320338.7

(51) Int. Cl. B29D 11/00

(52) U.S. Cl. 264/1.32; 264/2.5; 264/297.2; 264/297.8; 425/406; 425/808

(57) ABSTRACT

The present application relates to a method of moulding a contact lens using a male mould (3) and a female mould (5). The method comprises the steps of introducing lens-forming material in a liquid state into the female mould. The male mould is then inserted into the female mould to a first relative position to form an assembly of the male and female moulds in which the moulds together define a moulding cavity (11) and a reservoir (21) for lens-forming material. During the insertion of the male mould to the first position thereof, part of the liquid state lens-forming material is expelled from the moulding cavity to the reservoir. Curing of the lens-forming material is then initiated in the moulding cavity whilst keeping open a pathway between the moulding cavity and the reservoir so as to allow lens forming material to flow from the reservoir into the moulding cavity to compensate for shrinkage of the lensforming material during curing. An external force is applied on the assembly of moulds to insert the male mould further into the female mould to thereby close the moulding cavity and to seal off the moulding cavity from the reservoir. The lens-forming material is allowed to complete the transformation to a final, glassy solid state within the sealed moulding cavity. The formed contact lens is removed from the assembly of male and female moulds after the lens forming material has reached the final glassy solid state thereof. The invention also relates to apparatus for moulding a contact lens.

The present invention relates to a method of moulding contact lenses and apparatus for use in the method. More particularly, the present invention relates to a method and apparatus for cast moulding contact lenses.

The monomers used in the moulding of contact lenses typically shrink in volume by up to 20% during curing. It is a technical problem to devise a moulding method and moulding apparatus capable of dealing with the shrinkage. Otherwise the lens material may pull away from the mould surfaces. It is also a technical problem to ensure that the moulded lenses are very accurate in shape and need few or no further shaping operations once released from their moulds. Reliability of the moulding process is key and any technique will be unworkable from a practical point of view if there is a large post-moulding rejection rate.

It is known from WO 93/04848 to cast mould a contact lens in a moulding cavity formed between a male mould and a female mould. An outside circumferential surface of the female mould is tapered to receive an inside surface of the male mould to ensure that the mould sections are seated without interference while also ensuring that they are properly centred. A metered amount of monomer in a liquid state is introduced into the mould cavity and the male and female moulds are clamped together. The monomer is then polymerized withultraviolet exposure and the moulds unclamped. However, this moulding sequence may cause gas bubbles to be trapped inside the mould cavity when it is closed and the trapped gas may be introduced into the liquid monomer as gas bubbles and this may lead to imperfections in the moulded lens. Since the liquid monomer has a low viscosity when the mould cavity is closed the wettability of the moulds causes problems due to surface tension and capillary effects. Furthermore, the sealing of the moulding cavity when the moulds are clamped together prevents monomer being drawn back into the cavity to compensate for shrinkage.

It is also known from U.S. Pat. Nos. 4,113,224 and 4,197,266 to provide a reservoir of monomer outside the mould cavity so that during curing the monomer in the reservoir is drawn into the mould cavity as the monomer in the mould cavity shrinks. However, in the methods of these patents no clear pathway is provided allowing monomer to flow back into the mould from the reservoir. Instead monomer may be drawn back into the mould cavity from the reservoir through irregularities (e.g. small gaps and imperfections) in the moulds. Thus, the formed lenses have irregular edges and require further processing before use. If this were not the case then the mould would be sealed and no transfer of monomer from reservoir to mould cavity would be allowed and no compensation for shrinkage provided.

It is further known from EP 0383425 to provide a male mould which is a sliding fit inside a female mould. The method relies on pressure reduction in the mould cavity due to shrinkage in order to draw the moulds together. A hinge effect is created between the male and female moulds and relied upon to allow the moulds to move together. The hinge provides resistance to movement. This may lead to a relatively high negative pressure inside the mould cavity.

A further arrangement is known from U.S. Pat. No. 5,143,660 in which the male and female moulds have surfaces which are a close sliding fit to align them axially. The lenses are cured in a pressurised vessel, the increased pressure forcing the male and female moulds together. However, the increased pressure causes the moulds to flex and this may lead to inaccuracies in the moulded lenses.

In a first aspect the present invention provides a method of moulding a contact lens using a male mould and a female mould, the method comprising the steps of:
(a) introducing lens-forming material in a liquid state into the female mould;
(b) inserting the male mould into the female mould to a first relative position to form an assembly of the male and female moulds in which the moulds together define a moulding cavity and a reservoir for lens-forming material;
(c) during the insertion of the male mould to the first position thereof expelling part of the liquid state lens-forming material from the moulding cavity to the reservoir;
(d) initiating curing of the lens-forming material in the moulding cavity whilst keeping open a pathway between the moulding cavity and the reservoir so as to allow lens-forming material to flow from the reservoir into the moulding cavity to compensate for shrinkage of the lens-forming material during curing;
(e) applying an external force on the assembly of moulds to insert the male mould further into the female mould to thereby close the moulding cavity and to seal off the moulding cavity from the reservoir;
(f) allowing the lens-forming material to complete transformation to a final, glassy solid state within the sealed moulding cavity; and
(g) removing the formed contact lens from the assembly of male and female moulds after the lens-forming material has reached the final glassy solid state thereof.

The moulding cavity is kept open until the material therein has cured (at least partially), this advantageously allows shrinkage of the material to occur without inducing stresses in the male and female moulds.

It will be understood that the application of an external force on the assembly of moulds results in the male mould being displaced to a second relative position. The moulding cavity is sealed off from the reservoir when the male mould is in said second position.

A reduction in pressure in the mould cavity could induce dissolved gas to come out of solution and to form as bubbles in the lens-forming material. These bubbles could become trapped in the material when it is cured and then cause imperfections in the lens. However, keeping the moulding cavity open allows the bubbles to come out of solution and to escape from the mould cavity without being trapped in the material. Thus, the problem is ameliorated.

Furthermore, as the lens-forming material is cured (at least partially) before the male mould is displaced to said second position, the lens-forming material has become viscous before the mould cavity is closed and thus the likelihood of gas bubbles being trapped when the mould cavity is closed is reduced. The deleterious effects of surface tension and capillary forces are greatly ameliorated.

The material for forming the lens is preferably a monomer. The material for forming the lens is introduced into the female mould as a liquid. Shrinkage tends to occur particularly when the material undergoes a phase change, for example from a liquid to a gel, and from a gel to a solid. Thus, the moulding cavity is kept open until the material has undergone a phase change from a liquid state to a gel state.

A thickener is preferably added to the lens-forming material to increase the viscosity of the lens-forming material. Preferably the lens-forming material is maintained in the mould at a temperature above the glass transition temperature of the material until polymerisation is complete. The polymer in the mould cavity does not become a true glassy solid until it is below its glass transition temperature. While kept above the glass transition temperature the polymer remains deformable and the higher the temperature the softer the material.

The external force is preferably applied directly by mechanical apparatus, such as by a hydraulic or pneumatic ram. Most preferably, however, the external force is applied by a weight acting downwardly on one mould while the other mould is supported. Most preferably, the one mould is arranged above the other mould and a weight acts directly on the mould to provide the required closing force. A force should be chosen so as to avoid deformation of either the male or the female mould along their mating surfaces (which would result in imperfections of the formed lens) whilst ensuring the lens-forming material forming the lens in the mould cavity is severed from the material in the reservoir.

Viewed from a further aspect the present invention provides apparatus for moulding a contact lens comprising:

a male mould;

a female mould;

insertion means for inserting the male mould into the female mould to a first position relative to the female mould thereby to form an assembly of the male and female moulds in which there is defined a moulding cavity for retention of lens-forming material and a reservoir for storing an excess of lens-forming material, the mould cavity and the reservoir being in fluid communication when the male mould is in the first relative position; and

ram means for applying an external force on the assembly of male and female moulds to insert the male mould further into the female mould to a second position relative to the female mould, in which the mould cavity is closed and sealed off from the reservoir.

In order to create more positively the annular seal between the male and female moulds, the female mould is preferably provided with an annular lip suitable for abutting the male mould (or vice versa). It is further preferred that the male mould is provided with a frusto-conical region for abutting the annular lip on the female mould (or vice versa).

The matched moulds preferably have matched cylindrical portions. This arrangement advantageously aligns axially the male and female moulds and also helps to ensure that the closure force applied remains constant through the movement of the male and female moulds relative to each other.

The ram means preferably comprises a mass which, in use, acts on the assembly of moulds. Although a single mass may be used for acting on a plurality of assemblies of moulds (for example by providing projections associated with each assembly of male and female moulds), a single mass is preferably provided for each assembly of male and female moulds.

In arrangements utilising gravity loading, the apparatus preferably further comprises a lifting mechanism for lifting the mass or masses.

The assembly or assemblies of male and female moulds is/are preferably transported through the oven in a tray and the oven preferably comprises a plurality of rows of rollers for the tray to travel on. More preferably, at least one roller in one of said rows is preferably displaced vertically upwardly of the rollers in the other row(s). The vertical displacement of one of the rows of rollers acts a guide for the tray and facilitates thermal expansion of the tray in transverse directions. The rollers are preferably roller-balls.

The tray preferably has at least one heating element integrated into it to enable more accurate control of the temperature across the tray.

A preferred method according to the present invention will-now be described by way of example only and with reference to the accompanying drawings which show a preferred embodiment of moulding apparatus for use in the method and in which:

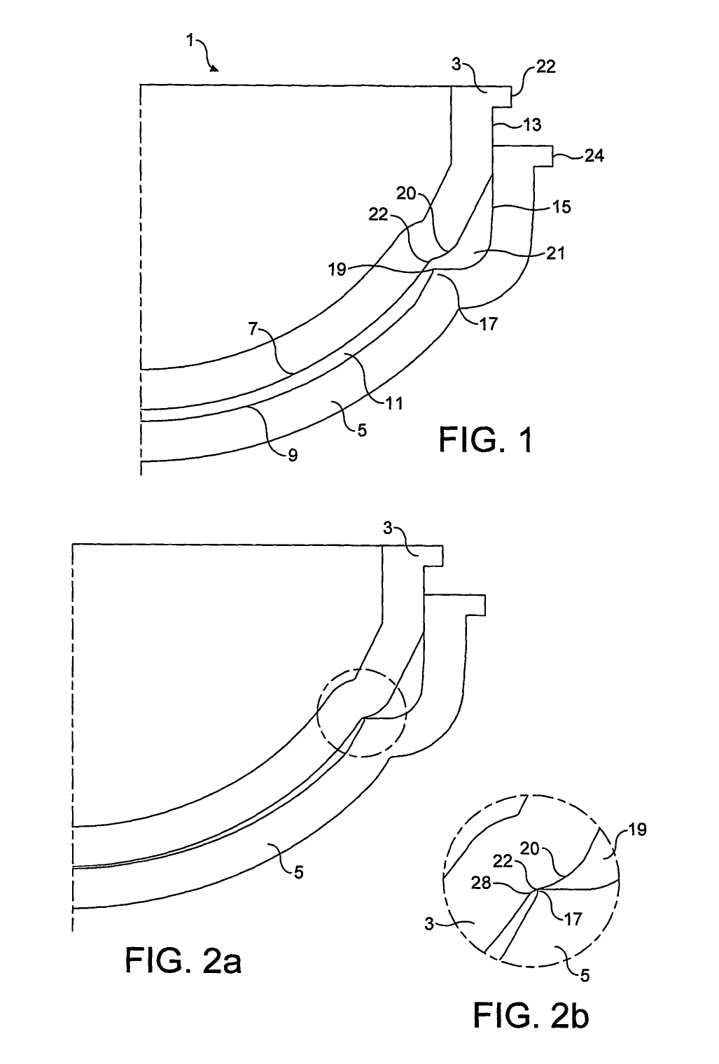

FIG. 1 shows a cross-section of the male and female moulds in the preferred embodiment of moulding apparatus, the moulds situated in a first relative position with the moulding cavity open;

FIGS. 2a and 2b show a cross-section of the male and female moulds of FIG. 1 in a second relative position with the moulding cavity closed; and

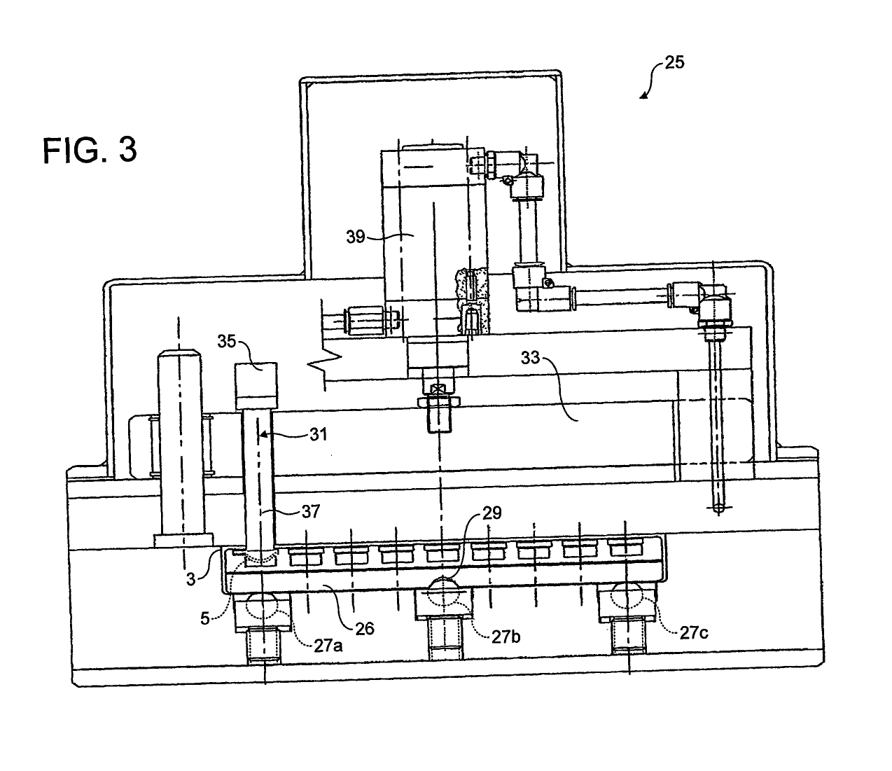

FIG. 3 shows a transverse cross-sectional view of an oven for curing the lens in accordance with the present invention.

The moulding apparatus 1 comprises a male mould 3 and a female mould 5. The male and female moulds 3 and 5 are injection moulded from polypropylene and are preferably substantially inflexible. The moulds 3 and 5 are for use only once in the manufacture of a single contact lens, but the moulds 3 and 5 are formed with a high dimensional accuracy.

The male mould 3 has a convex moulding surface 7 and the female mould a concave moulding surface 9. The moulding surfaces 7 and 9 are generally circular in transverse cross-section.

A moulding cavity 11, in which a contact lens (not shown) is moulded from a monomer, is defined between the convex surface 7 and the concave surface 9. The convex surface 7 of the male mould 3 defines the inner surface of the contact lens and the concave surface 9 of the female mould 5 defines the outer surface.

The male mould 3 is provided with an outer cylindrical surface 13, and the female mould 5 is provided with a matching inner cylindrical surface 15. The cylindrical surfaces 13 and 15 are sized such that the male mould 3 is an interference fit in the female mould 5. The interaction of the surfaces 13 and 15 ensures that the male mould 3 and the female mould 5 are axially aligned.

An annular lip 17 is provided around the concave surface 9 of the female mould 5. The lip 17 has an internal angle of approximately 90° and defines an external edge 19. The external edge 19 is circular in plan view and defines the edge of the moulding cavity 11. Thus, the radially outermost edge of the lens is defined by the edge 19.

An annulus 20 is provided around the convex surface 7 of the male mould 3. The annulus 20 and the convex surface 7 of the male mould 3 meet along a junction 22.

The lip 17 and annulus 20 have substantially uniform profiles and the edge 19 abuts the annulus 20, radially outwardly of the junction 22, to seal the moulding cavity 11 when the male mould 3 is displaced fully into the female mould 5, as shown in FIGS. 2a and 2b. An internal angle of

approximately 70° is defined in the moulding cavity 11 between the lip 17 and annulus 20 when they abut.

As the edge 19 engages the annulus 20 radially outwardly from the junction 22, a portion 28 of the annulus 20 defines a circumferential portion of the inside surface of a lens formed in the moulding cavity 11. This portion 28 is angularly offset from the convex surface 7 of the male mould 3 and the resulting lens is formed with a tapered edge, triangular when viewed in a cross-section extending radially of the lens. The edge comprises two surfaces which extend inwardly from the adjacent Lens surfaces to meet at a circular rim of the lens. This arrangement is preferable as the lens is more comfortable to wear. In the figure the two surfaces of the tapered edge are shown as frusto-conical in nature, but they could be radiussed surfaces meeting at a rounded rim.

An overflow cavity or reservoir 21 is defined between the male and female moulds 3 and 5 radially outwardly of the lip 17 and annulus 20, and radially inwardly of the cooperating surfaces 13 and 15. In the illustrated embodiment the reservoir 21 is annular, but in alternative embodiments the cavity 21 need not extend around the whole of the moulding cavity 11.

The male and female moulds 3 and 5 are provided with circumferential flanges 22 and 24 to assist their handling. Thus, curing of the monomer may be more accurately controlled.

The male 3 and female 5 moulds are formed with thicknesses chosen such that the moulds do not flex significantly during the moulding process. It is the intention of the present invention that the moulds are effectively inflexible so that the spherical lens forming surfaces do not bow during moulding of the lens.

An oven 25 for curing the contact lenses is shown in FIG. 3. The male and female moulds 3 and 5 are nested in recesses formed in the upper surface of a tray 26. The tray 26 travels through the oven along an axis perpendicular to the plane of FIG. 3 and may accommodate, for example, 100 pairs of male and female moulds 3 and 5 in a 10×10 array.

At least one heating element (not shown) is provided inside the tray 26 to facilitate temperature control across the tray. This arrangement enables the temperature to be maintained constant for all of the moulds 3 and 5 in the tray 26.

The tray 26 is slidably mounted on three parallel rows of roller balls 27A, 27B and 27C. The central row 27B is displaced upwardly relative to the side rows 27A and 27C and is received in a longitudinal groove 29 in the base of the tray 26. This arrangement advantageously guides the tray 26 through the oven 25 while allowing for thermal expansion of the tray 26 in transverse directions.

A weight 31 is associated with each pair of moulds 3 and 5 in the tray 26 (although only one weight is shown for clarity). The weight 31 has a head portion 35 and a shaft portion 37 which is slidably mounted in a table 33. The table 33 is itself displaceable vertically by a hydraulic ram 39.

When the table 33 is raised by the ram 39 it engages the underside of the head portion 35 and lifts the weight 31. When the table 33 is lowered the weight 31 rests on the upper surface of the associated male mould 3 and thereby externally applies a closing force. In its lowermost position, the head portion 35 of the weight is spaced upwardly from the upper surface of the table 33 (i.e. the table 33 over-travels) to ensure that it does not rest on the table 33. Thus, a uniform external load is applied by the weight 31.

The method of manufacturing a lens in accordance with the present invention will now be described with reference to a single lens, although it will be appreciated that in practice a plurality of lenses (for example 100) would be produced at the same time.

The first stage is to injection mould the male and female moulds 5 from a plastics material in accordance with known techniques. Preferably polypropylene is used, for reasons which will be described below. The polypropylene moulds are relatively hot when they are ejected from the moulding machine (typically 80° C.) and are therefore allowed to cool before they are used. If the moulds are not allowed to cool the temperature of the moulds may inadvertently trigger the polymerisation of the liquid monomer when it is introduced into them.

The female mould 5 is then placed in the tray 26 and a predetermined quantity of a liquid monomer (e.g. hydroxymethyl methacrylate) is introduced into the female mould. The male mould 3 is then inserted into the female mould 5 to a first position in which the moulding cavity 11 maintained open at its upper end, as shown in FIG. 1. The insertion of the male mould 3 into the female mould 5 causes some of the monomer material to be displaced out of the moulding cavity 11 and into the reservoir 21. In practice, the liquid monomer is introduced into a single female mould 5 and a male mould 3 inserted inside that female mould before repeating the process for the next pair of male and female moulds, i.e. the assemblies of male and female moulds are created consecutively, rather than simultaneously.

The tray 26 is then transported to the oven 25 and heated to a temperature in excess of 100° C. to cure the monomer. The liquid monomer in each mould cavity undergoes polymerisation when triggered by the heat of the oven. Thermal initiators on heating in the curing oven release free radicals which cause the polymerisation reaction to begin. The amount of free radicals released increases exponentially with temperature. Typically the time taken for a thermal initiator to release half of the available free radicals (half-life) at ambient temperature is days or months, whilst at 100° C. it is very short, i.e. minutes.

During polymerisation, the polymer chains increase in length and become entangled and then cross-link and this results in an increase in viscosity.

As the monomer is cured (i.e. as it polymerises) it shrinks, particularly as it undergoes phase changes. As the moulding cavity 11 is maintained open when the male mould 3 is in the first position, monomer (previously expelled from the lens forming cavity 11) may be drawn back from the reservoir 21 into the lens forming cavity 11 as shrinkage occurs. Moreover, maintaining the moulding cavity 11 open permits gas bubbles in the monomer (which form during the curing and shrinking of the monomer) to escape from the moulding cavity 11. The moulding cavity 11 is maintained open at least during the initial period in which the monomer undergoes a phase change from a liquid to a gel. The male mould 3 is retained in the first position with the mould cavity 11 open whilst the monomer begins polymerization. During this process first the polymer chains form, then grow in length, then become intensified and finally form cross-links, with viscosity increasing throughout.

The temperature of the oven 25 is maintained above the glass transition temperature (Tg) of the polymer produced from the polymerization of the liquid monomer so that the resultant polymer remains deformable.

During conversion of the liquid monomer to polymer the male mould 3 is displaced relative to the female mould 5 to its second position, thereby closing the mould cavity 11 and severing the lens material in the moulding cavity from the material in the reservoir of excess lens material. The timing of the closing of the mould will be determined empirically. On one hand it is best to leave the closing of the mould as late as possible to allow as much as possible of the polymerisation shrinkage to be absorbed by flow of previously expelled material from the reservoir back into the mould. On the other hand, once conversion has gone too far then there is a risk that closing the mould will induce stresses in the lens material. Thus it is best that the early shrinkage of the material in the mould is compensated for by keeping the mould open whilst the material is still sufficiently mobile to be drawn in from the reservoir. The mould is then shut before the viscosity of the material increases to such a level that there is an appreciable risk of inducing stress in the material by closing the mould.

After closure of the mould cavity the temperature of the material is kept above its glass transition temperature (Tg) until the conversion from a monomer to a polymer is complete.

After the conversion is complete then the material is allowed to cool and, as the temperature drops below Tg, it enters its glassy state.

Although volumetric shrinkage of the lens forming material may be considerable as the material is cooled below its glass transition temperature (Tg), the lens shape has already been fully formed so that the quality of the lens will not be compromised if, for example, the further shrinkage causes the lens forming material to pull away from the mould surface(s).

The higher the temperature above the glass transition temperature (Tg) the softer the lens forming material. However, the temperature is preferably controlled to ensure that the lens forming material is viscous when the male and female moulds are brought together so that when the moulds 3 and 5 are displaced relative to each other to said second position a residual positive pressure is created in the lens forming material. This residual positive pressure may help to allow for any shrinkage which may occur subsequently and also to help minimise deformation of the moulds 3 and 5 which may be caused by a negative pressure in the mould cavity 11. The viscosity of the lens forming material when the mould cavity 11 is closed may also help reduce the number and/or size of gas bubbles formed in the lens forming material. It may be desirable to add a thickening agent to the lens forming material to increase the viscosity of the lens forming material during the moulding process. The thickening agent is preferably also a plasticizer, such as glycerol. Advantageously, the thickening agent will lower the glass transition temperature (Tg) of the polymer and also reduce the overall shrinkage of the lens forming material.

Throughout the process the oven temperature must remain below the melting temperature of the male and female moulds 3, 5 (170° C. in the case of polypropylene moulds).

When the male mould 3 is displaced relative to the female mould 5 to the second position, the lip 17 and the annulus 20 abut each other to seal the moulding cavity 11. The male mould 3 is displaced to its second position by application of an external closing force by the weight 31. Specifically, the tray 33 is displaced to its lowermost position to cause the weight 31 to rest on the male mould 3. As mentioned above, the table 33 over-travels to ensure that the weight 31 does not rest on the table 33 (except when the table 33 is being raised) to ensure that a constant load is applied. The use of gravity loading to apply the external force ensures that a predetermined load is applied with a high degree of accuracy and repeatability.

With the male mould 3 in its second position, the polymer in the mould cavity is cooled and becomes a glassy solid, as mentioned above. The male and female moulds 3 and 5 may then be separated and the moulded contact lens removed and treated in accordance with known techniques. However, it should be appreciated that the configuration of the male and female moulds, in particular the arrangement of the lip 17 as described herein, facilitates accurate definition of the edge of the moulded lens. Thus, post-moulding work for lenses moulded in accordance with the present invention may be reduced.

The two moulds 3 and 5 together form a disposable cast. They are used in the formation of a single lens and then are disposed of or recycled to provide raw material for the formation of new moulds. The two moulds 3 and 5 are substantially inflexible and the moulding method does not rely upon flexing of a mould as an essential element of the moulding process. This is important to ensure that the process is repeatable with a high degree of accuracy, i.e. does not generate an unacceptably high percentage of poorly shaped lenses which must be rejected. The process avoids deformation of the edge 19 and avoids intrusion of the edge 19 into the facing surface. This increases the accuracy and repeatability of the process.

In the process of the present invention it is crucial that final movement of the male mould relative to the female mould is occasioned by an external force rather than solely by a vacuum created in the mould cavity by shrinkage of the monomer. The method uses the vacuum formed in the initial part of the curing to cause backflow of previously expelled monomer into the cavity rather than to occasion movement or flexing of the mould members. This has the added advantage of allowing a release path from the cavity 11 for gases which otherwise might form bubbles in the formed contact lens.

The final stage of using an external force to bring the two mould parts into abutment ensures that the edge of the formed lens is clearly defined and smooth and not rough and badly defined. The formation of the triangular cross-section edge (when the view is a cross-section in a radially extending plane) is very important for comfort of wear of the resulting contact lens. The external force is chosen to be sufficient to sever the lens-forming material in the moulding cavity from the material in the reservoir whilst not being sufficient to cause deformation of the male and female moulds (particularly along the line of engagement therebetween) which would result in undesirable irregularities in the finished lens. A closing force is maintained to ensure that the lens is effectively severed from the reservoir of excess lens material.

The cured lenses may be stored inside the polypropylene for months, if desired. However, the polypropylene may embrittle with age and, thus, the lenses are preferably not stored in the moulds for excessive periods of time.

The polymerisation of the monomer may be inhibited by the presence of oxygen and for this reason polypropylene is a particularly suitable material from which to make the male and female moulds 3,5 as it provides a good oxygen barrier. Moreover, polypropylene has a melting temperature of approximately 170° C., which is higher than the polymerisation activation temperature of the monomer. Polypropylene also has good release properties so facilitates more readily the extraction of the mould lens from the male and female moulds 3,5.

The method described above does not use sensors to judge the end of the curing phase (i.e. the end of the polymerisation) but instead experimentation will be used to provide a timed duration for the curing phase. A timer will be used to record the duration of the location of the moulds in the curing oven and to time the lowering of the tray 33 to occur at the optimum time during the curing/polymerisation. Of course, in alternative methods, sensors may be used to determine when to apply the external force to close the mould cavity.

The heating of the lens forming material above the glass transition temperature (Tg) of the resultant polymer may occur before polymerization has started, while it is taking place, or after it has been substantially completed. Indeed, heating of the lens forming material may initiate polymerization (although other initiation methods are also envisaged).

Although the present invention has been described with reference to a particular embodiment of the male and female moulds 3 and 5 and the oven 23, the skilled person will appreciate that various modifications may be made without departing from the scope of the invention. For example, the oven 25 may be replaced with a conventional oven.

The term polymer used herein includes co-polymers. Furthermore, the starting material for forming the lens is not necessarily a monomer but may be a polymer.

1. A method of moulding a contact lens using a male mould and a female mould, the method comprising the steps of:
(a) introducing lens-forming material in a liquid state into the female mould;
(b) inserting the male mould into the female mould to a first relative position to form an assembly of the male and female moulds in which the moulds together define a moulding cavity and a reservoir for lens-forming material;
(c) during the insertion of the male mould to the first position thereof expelling part of the liquid state lens-forming material from the moulding cavity to the reservoir;
(d) initiating curing of the lens-forming material in the moulding cavity whilst keeping open a pathway between the moulding cavity and the reservoir so as to allow lens-forming material to flow from the reservoir into the moulding cavity to compensate for shrinkage of the lens-forming material during curing;
(e) applying an external force on the assembly of moulds to insert the male mould further into the female mould to a second position relative to the female mould in which the moulding cavity is closed and sealed off from the reservoir;
(f) allowing the lens-forming material to complete transformation to a final, glassy solid state within the sealed moulding cavity; and
(g) removing the formed contact lens from the assembly of male and female moulds after the lens-forming material has reached the final glassy solid state thereof.

2. A method as claimed in claim 1 wherein:
the assembly of male and female moulds is heated to initiate curing of the lens-forming material.

3. A method as claimed in claim 1 wherein:
the male and female moulds are heated at least until the closing of the mould cavity and prior to the closing of the mould cavity the lens-forming material is kept at a temperature above the glass transition temperature of the lens-forming material;
the lens-forming material is cooled below the glass transition temperature in the closed moulding cavity; and
removing the formed contact lens from the mould cavity occurs after the lens-forming material has cooled below the glass transition temperature thereof.

4. A method as claimed in claim 1 wherein a thickener is added to the lens-forming material to increase the viscosity of the lens-forming material.

5. A method as claimed in claim 1 which includes the steps of:
forming the male and female moulds by an injection moulding process and using each pair of injection moulded male and female moulds only once in the formation of a single contact lens.

6. A method as claimed in claim 5 wherein:
a plurality of pairs of male and female moulds are injection moulded;
the liquid state lens forming material is deposited in the plurality of female moulds;
the plurality of male moulds are inserted into the female moulds, each being inserted to a first position in a respective female mould, to form a plurality of assemblies of male and female moulds;
the plurality of male moulds are all simultaneously displaced from the first positions thereof to the second positions thereof.

7. A method as claimed in claim 1 wherein:
the assembly(ies) of moulds is/are placed in a curing oven;
timing means is used to time duration of residence of the moulds in the curing oven; and
after a first measured time period the external force is applied to each male mould to move each male mould from the first position thereof to the second position thereof.

8. Apparatus for moulding a contact lens by the method of claim 1 comprising:
a male mould;
a female mould;
insertion means for inserting the male mould into the female mould; and
ram means;
wherein in making each contact lens the apparatus operates by:
inserting the male mould into the female mould to a first position relative to the female mould, the male mould and the female mould being adapted to together define a moulding cavity and a reservoir for lens forming material when the male mould is inserted into the female mould;
lens-forming material in liquid state previously introduced into the female mould being in part enclosed in the moulding cavity defined by the male and female moulds and in part expelled from the moulding cavity to the reservoir during insertion of the male mould into the female mould;
initiating curing of the lens-forming material in the moulding cavity whilst the male mould is in the first relative position and thereby keeping open a pathway between the moulding cavity and the reservoir so as to allow lens-forming materials to flow from the reservoir into the moulding cavity to compensate for shrinkage of the lens-forming material during curing;
the ram means applying an external force on the assembly of moulds to insert the male mould further into the female mould to a second position relative to the female mould in which the moulding cavity is sealed off from the reservoir; and
allowing the lens-forming material to complete transformation to a fixed, glassy solid state with the sealed moulding cavity.

9. Apparatus as claimed in claim 8 wherein the male and female moulds are shaped to provide the closed moulding cavity with an edge region triangular in cross-section.

10. Apparatus as claimed in claim 8 wherein the female mould is provided with an annular lip.

11. Apparatus as defined in claim 10 wherein said annular lip lies in a plane extending radially of the moulding cavity.

12. Apparatus as claimed in claim 11 wherein said male mould is provided with a frusto-conical region adjacent a spherical central region of the mould and the frusto-conical region abuts the annular lip of the female mould when the male mould is in the second position thereof.

13. Apparatus as claimed in claim 8 wherein the male mould has a cylindrical portion and the female mould has a matched cylindrical portion and the matched cylindrical portions co-operate to ensure the correct location of the male mould in the female mould.

14. Apparatus as claimed in claim 8 wherein each of the male and female moulds is an injection moulded mould and the assembly of moulds is for formation of a single contact lens.

15. Apparatus as claimed in claim 8 comprising a curing oven in which the assembly of male and female moulds is locatable.

16. Apparatus as claimed in claim 15 comprising timing means for timing duration of residence of the assembly of male and female moulds in the curing oven and triggering means for actuating the application of external force by the ram means when a chosen duration of residence is reached.

17. Apparatus as claimed in claim 16 wherein the ram means comprises a mass retention means for holding a mass in an elevated position above the male mould, which retention means releases the mass when triggered by the triggering means, the mass then falling to apply the external force on the assembly of moulds.

18. Apparatus as claimed in claim 17 which further comprises a lifting mechanism for lifting the mass to the elevated position thereof.

19. Apparatus as claimed in claim 15 wherein the base of the curing oven is provided with a plurality of rows of rollers, wherein at least one roller in one of said rows is displaced vertically upwardly of the rollers in the other row(s).

20. Apparatus as claimed in claim 19 wherein the rollers are roller-balls.

21. Apparatus as claimed in claim 19 or claim 20 comprising a tray for transporting the assembly of male and female moulds in the curing oven, the tray having a recess formed in the underside thereof for receiving at least a portion of each roller in said row of rollers displaced vertically upwardly of the other row(s) of rollers.

22-25. (canceled)
